(19) United States
(12) Patent Application Publication
(10) Pub. No.: US 2017/0075282 A1
(43) Pub. Date: Mar. 16, 2017

(54) PASTING DEVICE AND IMAGE FORMING APPARATUS

(71) Applicant: FUJI XEROX CO., LTD., Tokyo (JP)

(72) Inventors: Masayo HIGASHIMURA, Kanagawa (JP); Mitsuhiro MATSUMOTO, Kanagawa (JP); Keitaro MORI, Kanagawa (JP); Yuki YOKOYAMA, Kanagawa (JP)

(73) Assignee: FUJI XEROX CO., LTD., Tokyo (JP)

(21) Appl. No.: 14/982,950

(22) Filed: Dec. 29, 2015

(30) Foreign Application Priority Data
Sep. 16, 2015 (JP) 2015-182588

(51) Int. Cl. G03G 15/00

(52) U.S. Cl. CPC G03G 15/6541

(57) ABSTRACT

A pasting device includes a contact member disposed at a position that is downstream of a fixing unit that heats and fixes a developer transferred to a surface of a medium and that is upstream of a position at which a temperature of the heated developer decreases to a glass transition temperature with respect to a direction in which the medium is transported, the contact member contacting an image that has passed through the fixing unit; and a pasting member that is disposed downstream of the contact member with respect to the direction in which the medium is transported and that pastes a multilayered object to the surface of the medium.

### CROSS-REFERENCE TO RELATED APPLICATIONS

This application is based on and claims priority under 35 USC 119 from Japanese Patent Application No. 2015-182588 filed Sep. 16, 2015.

### BACKGROUND

### Technical Field

The present invention relates to a pasting device and an image forming apparatus.

### SUMMARY

According to an aspect of the invention, a pasting device includes a contact member disposed at a position that is downstream of a fixing unit that heats and fixes a developer transferred to a surface of a medium and that is upstream of a position at which a temperature of the heated developer decreases to a glass transition temperature with respect to a direction in which the medium is transported, the contact member contacting an image that has passed through the fixing unit; and a pasting member that is disposed downstream of the contact member with respect to the direction in which the medium is transported and that pastes a multilayered object to the surface of the medium.

### BRIEF DESCRIPTION OF THE DRAWINGS

Exemplary embodiments of the present invention will be described in detail based on the following figures, wherein:

FIG. 1 is an overall view of an image forming apparatus according to a first exemplary embodiment;

FIG. 2 is a partial view of the image forming apparatus according to the first exemplary embodiment;

FIG. 3 illustrates a continuous sheet according to the first exemplary embodiment;

FIG. 4 illustrates a postprocessing device according to the first exemplary embodiment;

FIG. 5A illustrates a surface of a rough-surfaced roller according to the first exemplary embodiment, FIG. 5B illustrates a surface of a rough-surfaced roller according to a first modification of the first exemplary embodiment, and FIG. 5C illustrates a surface of a rough-surfaced roller according to a second modification of the first exemplary embodiment;

FIG. 6A illustrates how a medium and a film are pasted to each other when an existing device is used, and FIG. 6B illustrates how a medium and a film are pasted to each other when the first exemplary embodiment is used; and

FIG. 7A illustrates developers used in the second embodiment before being fixed, FIG. 7B illustrates the developers after being fixed, and FIG. 7C corresponds to FIG. 6B of the first exemplary embodiment and illustrates a medium and a film that have been pasted to each other in the second exemplary embodiment.

### DETAILED DESCRIPTION

Hereinafter, exemplary embodiments of the present invention will be described with reference to the drawings. Note that the present invention is not limited to the exemplary embodiments described below.

To facilitate understanding the following description, the directions in the figures are defined as follows: the front-back direction is the X-axis direction, the left-right direction is the Y-axis direction, and the up-down direction is the Z-axis direction. The directions indicated by arrows X, −X, Y, −Y, Z, and −Z are respectively forward, backward, rightward, leftward, upward, and downward; or the front side, the back side, the right side, the left side, the upper side, and the lower side.

In each of the figures, a symbol “O” with “.” in it represents an arrow extending from the back side toward the front side of the plane of the figure, and a symbol “O” with “x” in it represents an arrow extending from the front side toward the back side of the plane of the figure.

In the figures, members that are not necessary for understanding the following descriptions are not illustrated.

### First Exemplary Embodiment

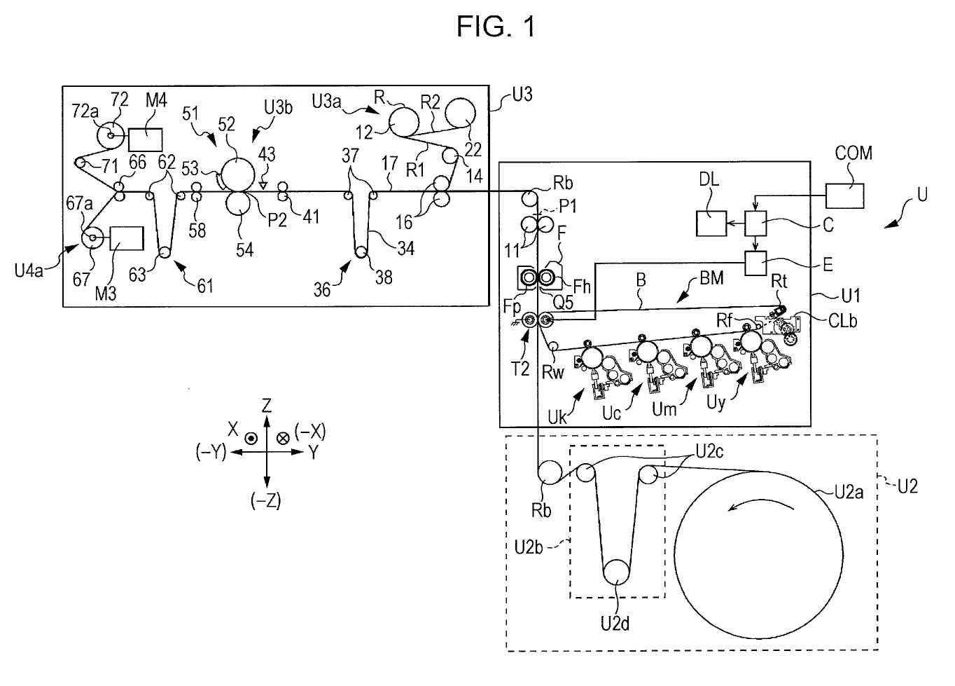

FIG. 1 is an overall view of an image forming apparatus according to a first exemplary embodiment.

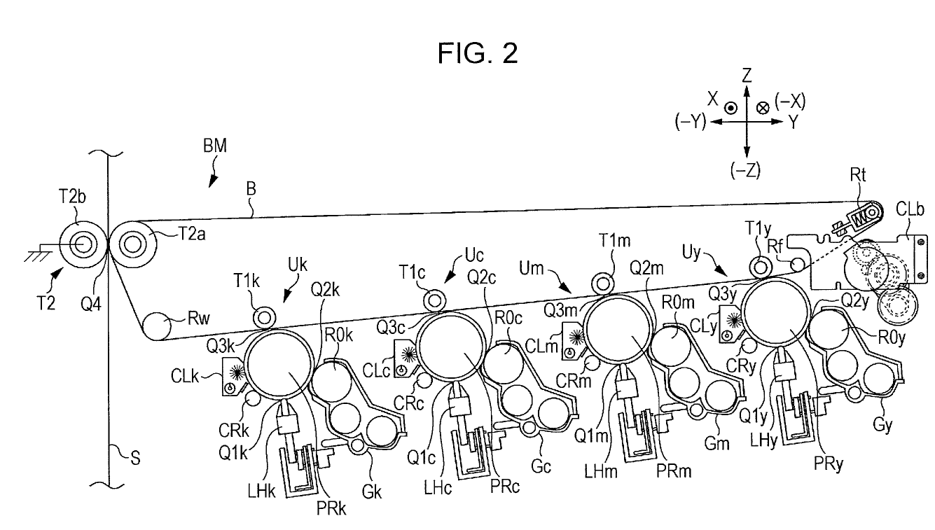

FIG. 2 illustrates a part of the image forming apparatus according to the first exemplary embodiment.

Referring to FIG. 1, a printer U, which is an example of an image forming apparatus according to the first exemplary embodiment of the present invention, includes a printer body U1, which is an example of a recording unit and an example of an image forming unit. The printer body U1 includes a controller C that controls the printer U. The controller C is electrically connected to a personal computer COM, which is an example of an information transmitting device. The controller C is capable of processing image information transmitted from the personal computer COM. The controller C is electrically connected to a writing circuit DL of the printer body U1. The writing circuit DL is electrically connected to LED heads LHy, LHm, LHc, and LHk, each of which is an example of a latent image forming device and an example of an exposure device.

The LED heads LHy, LHm, LHc, and LHk according to the first exemplary embodiment are arranged so as to correspond to yellow(Y), magenta (M), cyan (C), and black (K). Each of the LED heads LHy to LHk according to the first exemplary embodiment is an LED array, in which LEDs, each of which is an example of a light-emitting element, are linearly arranged in the width direction of an image. The LEDs of each of the LED heads LHy to LHk are capable of emitting light in accordance with an input signal. In other words, each of the LED heads LHy to LHk is capable of emitting a writing beam in accordance with an input signal.

Referring to FIG. 1, photoconductors PRy, PRm, PRc, and PRk, each of which is an example of an image carrier, are respectively disposed above the LED heads LHy to LHk. The photoconductors PRy to PRk respectively face the LED heads LHy to LHk in writing regions Q1y, Q1m, Q1c, and Q1k.

Charging rollers CRy, CRm, CRc, and CRk, each of which is an example of a charger, are respectively disposed upstream of the LED heads LHy to LHk with respect to the direction in which the photoconductors PRy, PRm, PRc, and PRk rotate. The charging rollers CRy to CRk according to the first exemplary embodiment are supported so as to be rotated while being in contact with the photoconductors PRy to PRk.

Developing device Gy, Gm, Gc, and Gk are respectively disposed downstream of the LED heads LHy to LHk with respect to the direction in which the photoconductors PRy to PRk rotate. The photoconductors PRy to PRk respectively face the developing devices Gy to Gk in development regions Q2y, Q2m, Q2c, and Q2k.

First-transfer rollers T1y, T1m, T1c, and T1k, each of which is an example of a first-transfer unit, are respectively disposed downstream of the developing devices Gy to Gk with respect to the direction in which the photoconductors PRy to PRk rotate. The photoconductors PRy to PRk respectively face the first-transfer rollers T1y to T1k in first-transfer regions Q3y, Q3m, Q3c, and Q3k.

Photoconductor cleaners CLy, CLm, CLc, and CLk, each of which is an example of an image carrier cleaner, are respectively disposed downstream of the first-transfer rollers T1y to T1k with respect to the direction in which the photoconductors PRy to PRk rotate.

The photoconductor PRy, the charging roller CRy, the LED head LHy, the developing device Gy, the first-transfer roller T1y, and the photoconductor cleaner CLy for yellow (Y) constitute an image-forming unit Uy for yellow (Y) according to the first exemplary embodiment. The image-forming unit Uy, which is an example of a visible image forming device for yellow (Y) according to the first exemplary embodiment, forms a toner image, which is an example of a visible image. Likewise, the photoconductors PRm, PRc, and PRk; the charging rollers CRm, CRc, and CRk; the LED heads LHm, LHc, and LHk; the developing devices Gm, Gc, and Gk; the first-transfer rollers T1m, T1c, and T1k; and the photoconductor cleaners CLm, CLc, and CLk respectively constitute image-forming units Um, Uc, and Uk for magenta (M), cyan (C), and black (K).

A belt module BM, which is an example of an intermediate transfer device, is disposed above the photoconductors PRy to PRk. The belt module BM includes an intermediate transfer belt B, which is an example of an image carrier and an example of an intermediate transfer member. The intermediate transfer belt B is an endless-belt-like member.

The intermediate transfer belt B according to the first exemplary embodiment is rotatably supported by a tension roller Rt, which is an example of a tension member; a walking roller Rw, which is an example of a deviation correcting member; an idler roller Rf, which is an example of a driven member; a backup roller T2a, which is an example of a second-transfer-region facing member and an example of a drive member; and the first-transfer rollers T1y, T1m, T1c, and T1k.

A second-transfer roller T2b, which is an example of a second-transfer member, is disposed so as to face a backup roller T2a with the intermediate transfer belt B therebetween. In the first exemplary embodiment, a power circuit E applies a second-transfer voltage, which has a polarity the same as that of the charge of toner, to the backup roller T2a; and the second-transfer roller T2b is grounded. The backup roller T2a and the second-transfer roller T2b constitute a second-transfer unit T2 according to the first exemplary embodiment. The second-transfer roller T2b is in contact with the intermediate transfer belt B in a second-transfer region Q4.

A belt cleaner CLb, which is an example of an intermediate transfer member cleaner, is disposed downstream of the second-transfer region Q4 with respect to the direction in which the intermediate transfer belt B rotates.

The first-transfer rollers T1y to T1k, the intermediate transfer belt B, the second-transfer unit T2, and the like constitute a transfer device T1+T2+B according to the first exemplary embodiment, which is an example of a transfer unit.

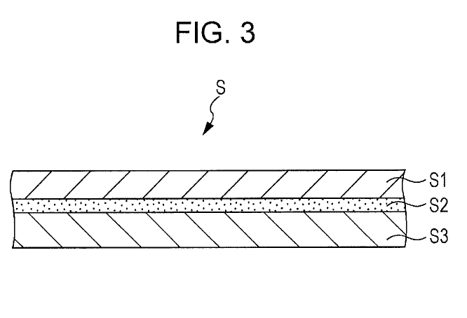

FIG. 3 illustrates a continuous sheet according to the first exemplary embodiment.

Referring to FIG. 1, a sheet feeding device U2, which is an example of a sheet feeding unit, is disposed below the image-forming units Uy to Uk. The sheet feeding device U2 includes a sheet feeding member U2a around which a continuous sheet S, which is an example of a medium, is wound. Referring to FIG. 3, the continuous sheet S according to the first exemplary embodiment is a so-called rolled label sheet, which includes a base sheet S1 having a front surface on which an image is to be printed, an adhesive S2 applied to a back surface of the base sheet S1, and a release sheet S3 to which an adhesive S2 is attached. In other words, the continuous sheet S according to the first exemplary embodiment includes a layer of the adhesive S2, which is an example of an adhesive layer, as a middle layer thereof.

The sheet feeding member U2a is rotatably supported. A tension application unit U2b, which is an example of a tension application device, is disposed on the left side of the sheet feeding member U2a. The tension application unit U2b includes two driven rollers U2c, each of which is an example of a support member and which support the continuous sheet S. A tension roller U2d, which is an example of a tension application member, is disposed between the driven rollers U2c. The tension roller U2d is supported so as to be movable in the up-down directions while being in contact with the continuous sheet S. The tension roller U2d applies a tension to the continuous sheet S by pushing the continuous sheet S downward with a gravitational force, thereby preventing the continuous sheet S from becoming creased.

The continuous sheet S extends from the sheet feeding device U2 toward the second-transfer region Q4 of the printer body U1.

A fixing device F, which is an example of a fixing unit, is disposed downstream of the second-transfer roller T2b with respect to the direction in which the continuous sheet S is transported. The fixing device F includes a heating roller Fh, which is an example of a heating member, and a pressing roller Fp, which is an example of a pressing member. A heater, which is an example of a heat source, is disposed in the heating roller Fh.

A guide roller Rb, which is an example of a guide member, is rotatably supported at a position downstream of the fixing device F.

A postprocessing device U3 is disposed downstream of the guide roller Rb. The postprocessing device U3 includes a lamination device U3a, which is an example of a pasting device. A cut-forming device U3b, which is an example of a cutting unit, is disposed downstream of the lamination device U3a.

A winding device U4a, which is an example of a recovery member, is disposed downstream of the postprocessing device U3. After the continuous sheet S has been postprocessed, the continuous sheet S is wound around the winding device U4a. The winding device U4a is driven by a motor M3, which is an example of a driving source.

### Description of Image Forming Operation

The printer U according to the first exemplary embodiment, having the structure described above, starts a printing operation when receiving image information from the personal computer COM. On the basis of the received image information, the controller C generates image information for forming latent images for yellow (Y), magenta (M), cyan (C), and black (K). The controller C outputs the generated image information to the writing circuit DL of the printer body U1. If the image is a monochrome image, the controller C outputs image information for only black (K) to the writing circuit DL.

The writing circuit DL outputs control signals to the LED heads LHy to LHk in accordance with input image information. The LED heads LHy to LHk emit laser beams in accordance with the control signals.

When an image forming operation is started, the photoconductors PRy to PRk starts rotating. The power circuit E applies a charging voltage to the charging rollers CRy to CRk. Accordingly, the charging rollers CRy to CRk charge the surfaces of the photoconductors PRy to PRk. The LED heads LHy to LHk emit writing beams to form electrostatic latent images on the surfaces of the charged photoconductors PRy to PRk in the writing regions Q1y to Q1k. The developing devices Gy, Gm, Gc, and Gk develop the electrostatic latent images on the photoconductors PRy to PRk in the development regions Q1y to Q2k so as to form toner images, each of which is an example of a visible image.

The developed toner images are transported to the first-transfer regions Q3y, Q3m, Q3c, and Q3k, in which the first-transfer rollers T1y to T1k contact the intermediate transfer belt B. The power circuit E applies a first-transfer voltage, having a polarity opposite to that of the charge of toner, to the first-transfer rollers T1y to T1k in the first-transfer regions Q3y, Q3m, Q3c, and Q3k. Accordingly, the first-transfer rollers T1y to T1k transfer the toner images on the photoconductors PRy to PRk to the intermediate transfer belt B. In the case of forming a multi-color toner image, on one of toner images transferred by one of the first-transfer units at an upstream position, another toner image is superposed by another first-transfer unit at a downstream position.

The photoconductor cleaners CLy to CLk clean the photoconductors PRy to PRk by removing substances remaining on and adhering to the photoconductors PRy to PRk after first-transfer. The charging rollers CRy to CRk charge the surfaces of the cleaned photoconductors PRy to PRk again.

The monochrome or multi-color toner image, which has been transferred to the intermediate transfer belt B by the first-transfer rollers T1y to T1k in the first-transfer regions Q3y to Q3k, is transported to the second-transfer region Q4.

The continuous sheet S is transported downstream by receiving a transport force in the second-transfer region Q4 and transport forces from the fixing device F and the winding device U4a.

The power circuit E applies a second-transfer voltage, which has a polarity the same as that of the charge of toner, to the backup roller T2a. Accordingly, the toner image on the intermediate transfer belt B is transferred to the continuous sheet S while the continuous sheet S passes through the second-transfer region Q4.

The belt cleaner CLb cleans the surface of the intermediate transfer belt B after second-transfer has been finished by removing adhering substances and the like from the surface.

While the continuous sheet S, on which the toner image has been second-transferred, passes through the fixing region Q5, the toner image is thermally fixed to the continuous sheet S.

The continuous sheet S, to which the image has been fixed, is transported to the postprocessing device U3. In the postprocessing device U3, the lamination device U3a pastes a laminate film, which is an example of a pasted object, to a surface of the continuous sheet S. In accordance with an image on the continuous sheet S, to which the laminate film has been pasted, the cut-forming device U3b forms a cut in the base sheet S1 and the adhesive S2 of the continuous sheet S.

While passing through the postprocessing device U3, a frame-shaped portion of the continuous sheet S that surrounds the image and along which the cut has been formed, which is a so-called scrap sheet, is removed from the postprocessed continuous sheet S and wound around the winding device U4a.

### Description of Postprocessing Device U3

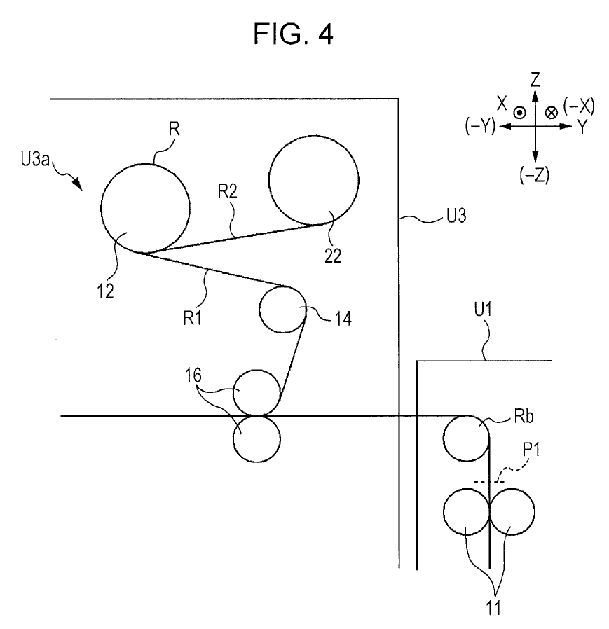

FIG. 4 illustrates the postprocessing device U3 according to the first exemplary embodiment.

Referring to FIGS. 1 and 4, the lamination device U3a according to the first exemplary embodiment includes rough-surfaced rollers 11, which are an example of a contact member. The rough-surfaced rollers 11 are in contact with the continuous sheet S at a position downstream of the fixing unit F. The rough-surfaced rollers 11 according to the first exemplary embodiment are disposed upstream of a position P1, at which the temperature of the developer that has passed through the fixing unit F decreases to the glass transition temperature of the developer due to natural heat dissipation or natural cooling, with respect to the direction in which the continuous sheet S is transported. As a result, the rough-surfaced rollers 11 according to the first exemplary embodiment are disposed upstream of the guide roller Rb. In the first exemplary embodiment, because of the difference between the compositions of the developers for Y, M, C, and K, such as a colorant content, the glass transition temperatures of the developers slightly differ from each other. For example, the position P1 is determined on the basis of the highest glass transition temperature. However, this is not a limitation. For example, the position P1 may be determined on the basis of the glass transition temperature of a developer forming the uppermost layer, which is a yellow developer in the first exemplary embodiment. Therefore, in the first exemplary embodiment, the rough-surfaced rollers 11 may be made of a heat-resistant material, because the rough-surfaced rollers 11 contact the continuous sheet S on which an image has been just fixed and which has a high temperature. Thus, in the first exemplary embodiment, the rough-surfaced rollers 11 are made of a metal, which is an example of a heat-resistant material. Instead of metal rollers, rollers that are coated with a heat-resistant material may be used as the rough-surfaced rollers 11.

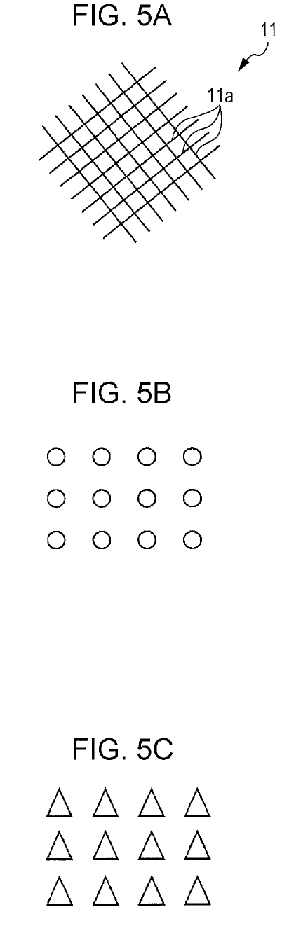

FIG. 5A illustrates a surface of a rough-surfaced roller according to the first exemplary embodiment, FIG. 5B illustrates a surface of a rough-surfaced roller according to a first modification of the first exemplary embodiment, and FIG. 5C illustrates a surface of a rough-surfaced roller according to a second modification of the first exemplary embodiment.

Each of the rough-surfaced rollers 11 according to the first exemplary embodiment is a cylindrical roller. Referring to FIG. 5A, asperities 11a are reformed on the outer surface of the rough-surfaced roller 11. In the first exemplary embodiment, the asperities 11a are formed by grooves that are arranged in a lattice-like shape with a 1 μm pitch and that have a depth in the range of, for example, about 1 to 2 μm. The sizes of the asperities 11a may be appropriately determined in accordance with the size of developer particles, the material of an adhesive layer, and the like, as long as the asperities 11a increase the surface area of a laminate film R (described below) when bonding the laminate film R. Thus, although not limited to the exemplary value, when the mean particle diameter is small, an effect on image quality is reduced.

The shape of the asperities is not limited to a lattice-like shape illustrated in FIG. 5A. The asperities may be formed by semispherical projections shown in FIG. 5B or by prism-shaped projections shown in FIG. 5C. Other than the examples shown in FIGS. 5A to 5C, the asperities may be formed by polygonal cones or polygonal columns.

The asperities need not be regularly arranged as shown in FIGS. 5A to 5C and may be irregularly arranged. Accordingly, irregular asperities may be formed by bead blasting or the like.

Instead of forming the asperities or performing bead blasting, a roller having a rough surface that is naturally formed in a manufacturing process, such as a roller made of a foamed material, may be used.

A film supply roller 12, which is an example of a multilayered object supply unit, is disposed in an upper left part of the lamination device U3a according to the first exemplary embodiment. The film supply roller 12 is rotatable. A strip-shaped laminate film R, which is an example of a multilayered object, is wound around the film supply roller 12. As with the continuous sheet S, the laminate film R according to the first exemplary embodiment has a continuous strip-like shape. The laminate fil R includes a film body R1, which is the body of the multilayered object; a bonding layer; and a release sheet R2. The film body R1 according to the first exemplary embodiment may be made from a thin resin film. For example, a polyethylene terephthalate (PET) film, which transmits light, may be used.

A winding roller 22, which is an example of a winding member, is disposed on the right side of the film supply roller 12. A driving force is transmitted from a winding motor (not shown), which is an example of a driving system, to the winding roller 22 according to the first exemplary embodiment. In the first exemplary embodiment, the winding roller 22 is rotatable by being driven by the winding motor. One end of the release sheet R2 of the laminate film R is held by the winding roller 22. Thus, when the winding roller 22 rotates, the release sheet R2 is wound around the winding roller 22, and the release sheet R2 is removed from the film body R1. A guide roller 14, which is an example of a guide member, is disposed below the film supply roller 12.

Pasting rollers 16, which are examples of a pasting member, are disposed below the guide roller 14. A driving force is transmitted from a drive motor, which is an example of a driving system, to the pasting rollers 16. Thus, the pasting rollers 16 rotate while nipping the continuous sheet S and the film body R1 therebetween. At this time, the continuous sheet S and the film body R1, which are nipped between the pasting rollers 16, are pasted to each other via a bonding layer of the laminate film R. Thus, the film body R1 and the continuous sheet S are layered and pasted to each other by the pasting rollers 16 according to the first exemplary embodiment to form a pasted object 17.

A first buffer device 36, which is an example of a tension adjustment device, is disposed on the left side of the pasting roller 16. The first buffer device 36 includes a pair of first support rollers 37, which are examples of a support member. The first support rollers 37 according to the first exemplary embodiment are arranged in the direction in which the medium is transported. In the first exemplary embodiment, the pasted object 17 is supported by the first support rollers 37. The first buffer device 36 includes a first dancer roller 38, which is an example of a first adjustment member, between the first support rollers 37 with respect to the direction in which the medium is transported.

The first dancer roller 38 according to the first exemplary embodiment extends in the front-back direction. A front end portion and a back end portion of the first dancer roller 38 are supported by a frame (not shown) so that the first dancer roller 38 is movable in the up-down direction and rotatable. In the first exemplary embodiment, the first dancer roller 38 is in contact with the upper surface of the pasted object 17, and a tension is applied to the pasted object 17 due to the weight of the first dancer roller 38.

The cut-forming device U3b includes first transport rollers 41, which are examples of a transport unit. The first transport rollers 41 according to the first exemplary embodiment are disposed downstream of the first buffer device 36 with respect to the direction in which the medium is transported. A forward rotational force or a backward rotational force is transmitted from a first transport motor (not shown), which is an example of a driving system, to the first transport rollers 41 according to the first exemplary embodiment. In the first exemplary embodiment, the first transport rollers 41 are rotated by the first transport motor while nipping the pasted object 17 therebetween and transport the pasted object 17 downstream or upstream with respect to the direction in which the medium is transported.

A rotary die cutter 51, which is an example of a cutting member, is disposed on the left side of the first transport rollers 41.

Referring to FIG. 1, the rotary die cutter 51 includes a die-cut roller 52, which is an example of a rotational body. The die-cut roller 52 according to the first exemplary embodiment extends in the front-back direction. A driving force is transmitted to the die-cut roller 52 from a driving source (not shown), and the die-cut roller 52 rotates.

A cutting edge 53 is disposed on a part of the outer peripheral surface of the die-cut roller 52. The cutting edge 53 according to the first exemplary embodiment has a frame-like shape corresponding to the outline of an image recorded on the pasted object 17. The cutting edge 53 protrudes outward from the surface of the die-cut roller 52.

An anvil roller 54, which is an example of a facing member, is disposed below the die-cut roller 52. The anvil roller 54 according to the first exemplary embodiment extends in the front-back direction. The die-cut roller 52 and the anvil roller 54 face each other with a clearance, which corresponds to the length of the cutting edge 53 and the thickness of the release sheet S3, therebetween. In the first exemplary embodiment, the length of the cutting edge 53 and the clearance between the die-cut roller 52 and the anvil roller 54 are set so that, when the cutting edge 53 moves to a cutting position P2 as the die-cut roller 52 rotates, the cutting edge 53 penetrates through the film body R1, the bonding layer, the base sheet S1, and the adhesive S2 but does not penetrate through the release sheet S3 from the upper surface of the pasted object 17.

Referring to FIG. 1, second transport rollers 58, which are examples of a transport unit, are disposed on the left side of the rotary die cutter 51. A forward rotational force or a backward rotational force is transmitted from a second transport motor (not shown), which is an example of a driving system, to the second transport rollers 58 according to the first exemplary embodiment. In the structure according to the first exemplary embodiment, the first transport motor and the second transport motor are driven in synchronism with each other. The second transport rollers 58 are rotated by the second transport motor while nipping the pasted object 17 therebetween and transport the pasted object 17 downstream or upstream with respect to the direction in which the medium is transported.

A second buffer device 61, which is an example of a tension adjusting device, is disposed on the left side of the second transport rollers 58. The second buffer device 61, which has a structure similar to that of the first buffer device 36, includes a pair of rollers 62 and a roller 63, which respectively correspond to the pair of rollers 37 and the roller 38 of the first buffer device 36.

Branch rollers 66, which are an example of a branch member, are disposed on the left side of the second buffer device 61. Referring to FIG. 1, the branch rollers 66 according to the first exemplary embodiment are rotatable.

A second winding roller 67, which is an example of a second winding member, is disposed on the lower left side of the branch rollers 66. A driving force is transmitted from a second winding motor M3, which is an example of a driving system, to a rotation shaft 67a of the second winding roller 67. In the first exemplary embodiment, the second winding roller 67 is rotatable by being driven by the second winding motor M3. The release sheet S3, having a label member thereon, is held by the second winding roller 67. The label member, which is an example of a sticking label, is a part of the pasted object 17 around which the die-cut roller 52 has formed a cut. Accordingly, the label member, which is held on the release sheet S3, is wound around the second winding roller 67.

A guide roller 71, which is an example of a guide member, is disposed on the upper left side of the branch rollers 66. A first winding roller 72, which is an example of a recovery unit and an example of a first winding member, is disposed above the guide roller 71. A driving force is transmitted from a first winding motor M4, which is an example of a driving system, to a rotation shaft 72a of the first winding roller 72. In the first exemplary embodiment, the first winding roller 72 is rotatable by being driven by the first winding motor M4. One end of a scrap member, which is an example of a waste member, is held by the first winding roller 72. The scrap member, which is a frame-shaped member, is a portion of the pasted object 17 that remains after the label member has been removed. Thus, the scrap member is wound around the first winding roller 72.

### Function of Postprocessing Device According to First Exemplary Embodiment

In the printer U according to the first exemplary embodiment having the structure described above, when an image formed on the continuous sheet S passes through the fixing device F, the developer in the image is heated, pressed, and melted, and the image is fixed to the continuous sheet S. After passing through the fixing unit F, the image contacts the rough-surfaced rollers 11 before the temperature of the developer decreases to the glass transition temperature of the developer. Due to contact with the rough-surfaced rollers 11, fine asperities are formed on the surface of the image. When the image on which the asperities have been formed passes through the pasting roller 16, the film body R1 of the laminate film R is pasted to a part of the continuous sheet S on which the image has been formed.

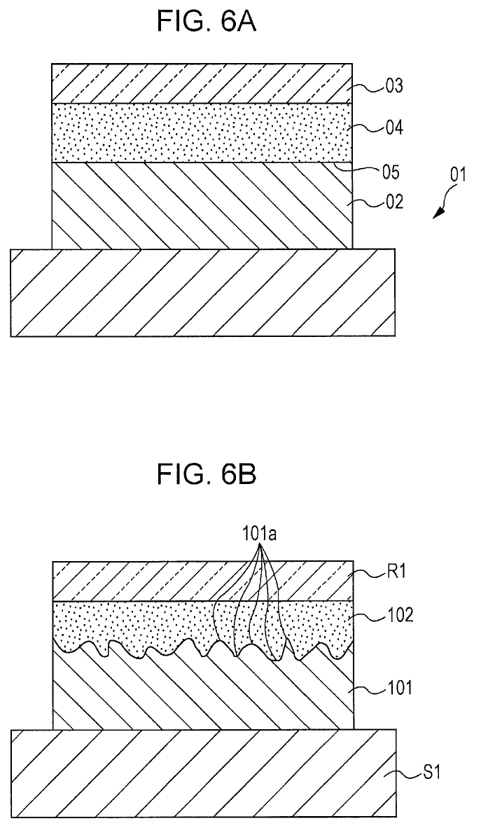

FIG. 6A illustrates how a medium and a film are pasted to each other when an existing device is used, and FIG. 6B illustrates how a medium and a film are pasted to each other when the first exemplary embodiment is used.

Referring to FIG. 6A, when an existing device, which does not have the rough-surfaced rollers 11, is used, a pasting surface 05 between of a toner layer 02 on a medium 01 and a bonding layer 04 on a film body 03 of the laminate film is a smooth surface. Accordingly, the contact area between the toner layer 02 and the bonding layer 04 is small, and the adhesion between the toner layer 02 and the bonding layer 04 may be weak. Accordingly, the film body 03 might be accidentally removed from the medium 01.

In the first exemplary embodiment, after an image has been fixed to the continuous sheet S and before the laminate film R is pasted to the continuous sheet S, the rough-surfaced rollers 11 contact the surface of the continuous sheet S. In particular, the rough-surfaced rollers 11 contact the developer before the temperature of the developer decreases to the glass transition temperature. Accordingly, the developer, which is melted when fixing an image, contacts the rough-surfaced rollers 11 before the developer solidifies, and therefore asperities are formed on the surface of the image. Accordingly, referring to FIG. 6B, a bonding layer 102 of the film body R1 is pasted to the surface of an image 101 on the surface of the base sheet S1 in a state in which asperities 101a are formed on the surface of the image 101. Accordingly, when the first exemplary embodiment is used, the contact area between the image 101 and the bonding layer 102 is increased as compared with a case where the existing device is used. Thus, occurrence of accidental removal of the film body R1 from the base sheet S1 is reduced.

In particular, in the first exemplary embodiment, the film body R1 is pasted to the continuous sheet S while being pressed by the pasting roller 16. Thus, adhesive of the bonding layer 102 enters the gaps between the asperities of the image 101. Accordingly, the adhesive is likely to be wedged into the gaps. Thus, the image 101 and the bonding layer 102 are likely to be securely bonded to each other. Accordingly, as compared with a case where pressing is not performed during pasting, occurrence of accidental removal of the film body R1 from the base sheet S1 is further reduced.

In the first exemplary embodiment, the sizes of the asperities of the rough-surfaced rollers 11 are in the range of about 1 to 2 μm. Accordingly, the sizes of the asperities formed on the image 101 are also in the range of about 1 to 2 μm. In recent years, developers having a volume mean particle diameter in the range of about 3 to 10 μm have been usually used. Therefore, the image 101, in which four color developers are layered after being fixed, is likely to have a thickness in the range of about 3 to 25 μm. If asperities having sizes larger than the thickness of the image 101 were formed, decrease in the image quality might become conspicuous. However, with the first exemplary embodiment, the image quality is only marginally affected by the presence of the asperities, because the asperities are smaller than the thickness. Thus, as compared with a case where the sizes of asperities are large, decrease in the image quality is suppressed. In particular, regarding the gloss of the image 101, the surface of the laminate film R is more influential than the surface of the image 101 itself. Thus, the asperities formed on the surface of the image 101 do not substantial affect the gloss.

### Second Exemplary Embodiment

Next, a second exemplary embodiment of the present invention will be described. In the following description of the second exemplary embodiment, elements of the second exemplary embodiment corresponding to those of the first exemplary embodiment will be denoted by the same numerals and detailed description of such elements will be omitted.

The second exemplary embodiment differs from the first exemplary embodiment in the following respects. In other respects, the second exemplary embodiment is the same as the first exemplary embodiment.

A printer U according to the second exemplary embodiment differs from that of the first exemplary embodiment in that the rough-surfaced rollers 11 are omitted and different developers are used. Because the structure of the printer U is the same as that of the first exemplary embodiment in other respects, illustrations of the printer U will be omitted.

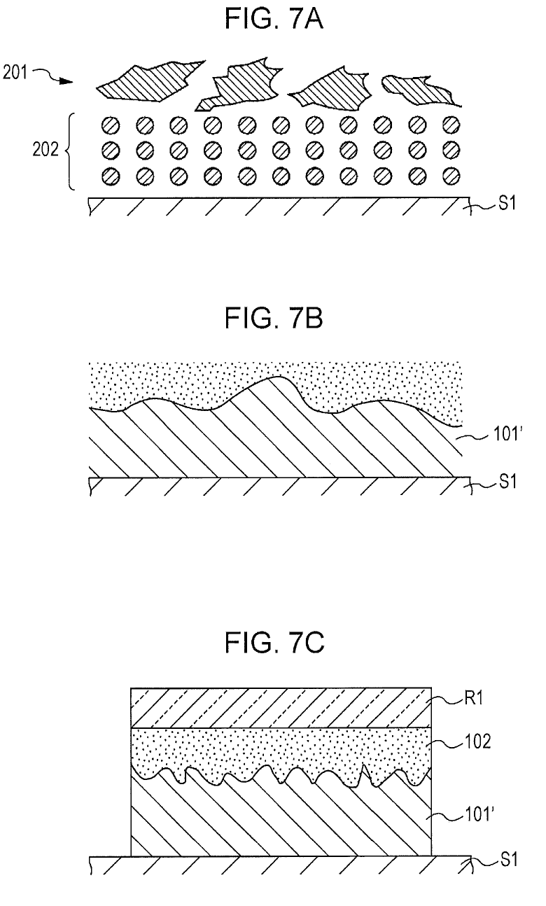

FIG. 7A illustrates developers used in the second embodiment before being fixed, FIG. 7B illustrates the developers after being fixed, and FIG. 7C corresponds to FIG. 6B of the first exemplary embodiment and illustrates a medium and a film that have been pasted to each other in the second exemplary embodiment.

Referring to FIGS. 7A to 7C, in the second exemplary embodiment, as with the first exemplary embodiment, in an image transferred to the continuous sheet S, developers for K, C, M, and Y are layered in this order from the base sheet S1 side. In the second exemplary embodiment, a developer 201 for Y color, which forms the uppermost layer, has a mean particle diameter larger than those of developers 202 for M, C, and K colors. For example, in the second exemplary embodiment, the volume mean particle diameter of the developer 201 for Y color is about 10 μm, and the volume mean particle diameter of the developers 202 for M, C, and K colors is about 3 μm.

In the second exemplary embodiment, the volume mean particle diameter was measured by using a Coulter Multisizer II made by Beckman Coulter, Inc. A 1% NaCl aqueous solution made by using first-grade sodium chloride was used as an electrolyte solution. For example, ISOTON-II (made by Coulter Scientific Japan Co., Ltd.) may be used. The measurement method was as follows: 0.1 to 5 ml of a surfactant (such as alkylbenzene sulfonate) was added, as a dispersant, to 100 to 150 ml of the electrolyte solution; and 2 to 20 mg of a measurement sample was further added. The electrolytic solution, in which the sample was suspended, was subjected to dispersion treatment for approximately 1 to 3 minutes by using a supersonic disperser. The volume or the number of toner particles was measured for each channel by using the measurement device, whose aperture was set to be 100 μm, and the volume % distribution or the number % distribution of the toner were calculated.

In the second exemplary embodiment, the developer 201 for Y color is composed of irregularly shaped particles, and the other developers 202 for M, C, and K colors are composed of spherical particles. For example, in the second exemplary embodiment, a pulverized toner, which is made by crushing a toner material, may be used as the developer composed of irregularly shaped particles. A polymerized toner, which is made by emulsion polymerization, may be used as the developer composed of spherical particles.

Moreover, in the second exemplary embodiment, the viscoelasticity of the developer 201 for Y color, which forms the uppermost layer, is higher than those of the developers 202 for M, C, and K colors. Toners having different viscoelasticities may be made by increasing the viscoelasticity of some of the toners by using a binder resin having a higher molecular weight or by decreasing the viscoelasticity of some of the toners by adding a crystalline resin.

### Function of Second Exemplary Embodiment

In the printer U according to the second exemplary embodiment having the structure described above, the mean particle diameter of the developer 201 for Y color forming the uppermost layer is larger than those of the developers 202 for other colors. Accordingly, compared with a case where the mean particle diameter of the developer forming the uppermost layer is smaller than or equal to those of the developers for other colors, asperities are likely to be formed on the uppermost surface of the developers. Accordingly, when the developer is fixed by heated and melted, asperities tend to remain on the surface of the developer 101′. Thus, in the printer U according to the second exemplary embodiment, as with the first exemplary embodiment, the contact area between the bonding layer 102 and the developer 101′ is likely to be increased due to the presence of the asperities on the surface of the developer 101′. Accordingly, the film body R1 is not likely to be accidentally removed.

In the second exemplary embodiment, the developer 201 for Y color forming the uppermost layer is composed of irregularly shaped particles. Accordingly, projections are likely to be formed on the surface of the developer 201 forming the uppermost layer. Thus, when the developer 201 is fixed by being melted, asperities are likely to be formed due to the projections on the surface of the developer 101′. Accordingly, in the printer U according to the second exemplary embodiment, as with the first exemplary embodiment, the contact area between the bonding layer 102 and the developer 101′ is increased due to the presence of asperities on the surface of the developer 101′. The adhesive in the bonding layer 102 is likely to wedge into gaps between the asperities, which are formed due to the projections. Thus, the film body R1 is not likely to be accidentally removed.

Moreover, in the second exemplary embodiment, the viscoelasticity of the developer 201 for Y color forming the uppermost layer is higher than those of the developers 202 for other colors. In general, as the viscoelasticity of a developer increases, the melting point of the developer increases. Accordingly, the developer 201 for Y color is not easily melted when being fixed as compared with the developers 202 for other colors. That is, the developer 201 forming the uppermost layer is likely to remain unmelted in a fixing operation. Accordingly, asperities generated due to the particle diameter or the irregular shape of particles of the developer is likely to remain on the uppermost layer. Thus, as compared with a case where the viscoelasticity of the developer 201 for Y color is lower than or equal to those of the developers 202 for other colors, the asperities are more likely to remain on the surface of the developer 101′ and the contact area is likely to be increased.

### Modifications

The present invention is not limited to the exemplary embodiments described above and may be modified in various ways within the spirit and scope of the present invention described in the claims. Examples of modifications (H01) to (H07) of the present invention are as follows.

(H01) In the exemplary embodiments described above, the printer U is described an example of an image forming apparatus. However, this is not a limitation. The image forming apparatus may be, for example, a copier, a fax, or a multifunctional machine having some or all of the functions of these.

(H02) In the exemplary embodiments described above, the printer U uses developers for four colors. However, this is not a limitation. For example, the present invention may be applied to a monochrome image forming apparatus or a multi-color image forming apparatus using developers for less than three or more than four colors. It is not necessary that an image forming apparatus according to the present invention include the intermediate transfer belt B. Alternatively, the present invention may be applied to an image forming apparatus that directly transfers an image to a medium from the photoconductors PRy to PRk.

(H03) In the exemplary embodiments described above, the buffer devices 36 and 61 may be omitted.

(H04) In the exemplary embodiments described above, the postprocessing device includes the rotary die cutter 51. However, this is not a limitation. For example, the rotary die cutter 51 or the structure for winding a scrap member may be omitted. In this case, a continuous sheet S in which portions of base sheets S1, on which images are to be recorded, are arranged on the release sheet S3 at predetermined intervals may be used. For example, the postprocessing device may include devices that perform other postprocessing operations, such as forming a folding line and forming a hole.

(H05) In the second exemplary embodiment, as the developer for Y color, a developer that has a large mean particle diameter, that is composed of irregularly shaped particles, and that has a high viscoelasticity is used as an example. However, this is not a limitation. For example, the developer for Y color may differ from other developers for other colors in one or two of the following properties: the mean particle diameter, the shape of the particles, and the viscoelasticity. In other respects, the developer for Y color may be the same as the other developers. While using developers having substantially the same mean particle diameter as developers for Y, M, C, and K colors, a fifth image forming unit that uses a transparent developer may be provided and an image may be formed so that the transparent developer forms an uppermost layer, and the mean particle diameter of the transparent developer may differ from those of the developers for the Y to K colors.

(H06) In the first exemplary embodiment, the contact member is a roller that rotates. Alternatively, the contact member may be a pad-shaped member that does not rotate. In this case, asperities formed on the image 101 are linear protrusions and recesses extending in the direction in which the continuous sheet S is transported.

(H07) The features of first exemplary embodiment and the second exemplary embodiment may be used in combination. That is, in a pasting device including the rough-surfaced rollers 11, a developer for Y color having properties different from those of developers for other colors may be used.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A pasting device comprising:
a contact member disposed at a position that is downstream of a fixing unit that heats and fixes a developer transferred to a surface of a medium and that is upstream of a position at which a temperature of the heated developer decreases to a glass transition temperature with respect to a direction in which the medium is transported, the contact member contacting an image that has passed through the fixing unit; and
a pasting member that is disposed downstream of the contact member with respect to the direction in which the medium is transported and that pastes a multilayered object to the surface of the medium.

2. The pasting device according to claim 1,
wherein the contact member includes a rotational body that has a peripheral surface that contacts the image, the peripheral surface having asperities.

3. An image forming apparatus comprising:
an image carrier;
a developing device that develops a latent image on a surface of the image carrier by using a developer;
a transfer unit that transfers an image on the surface of the image carrier to a medium;
a fixing unit that heats the image transferred by the transfer unit and that fixes the image onto the medium;
a contact member disposed at a position that is downstream of the fixing unit and that is upstream of a position at which a temperature of a heated developer decreases to a glass transition temperature with respect to a direction in which the medium is transported, the contact member contacting the image that has passed through the fixing unit; and
a pasting member that is disposed downstream of the contact member with respect to the direction in which the medium is transported and that pastes a multilayered object to a surface of the medium.

4. The image forming apparatus according to claim 3,
wherein the image transferred to the medium includes a plurality of layers of developers, and one of the developers forming an uppermost one of the layers has a volume mean particle diameter that is larger than those of the other developers forming lower layers.

5. The image forming apparatus according to claim 3,
wherein the image transferred to the medium includes a plurality of layers of developers, and one of the developers forming an uppermost one of the layers is composed of irregularly shaped particles and the other developers forming lower layers are composed of spherical particles.

6. The image forming apparatus according to claim 4,
wherein the one of the developers forming the uppermost one of the layers is composed of irregularly shaped particles and the other developers forming lower layers are composed of spherical particles.

7. The image forming apparatus according to claim 3,
wherein the image transferred to the medium includes a plurality of layers of developers, and one of the developers forming an uppermost one of the layers has a higher viscoelasticity than the other developers forming lower layers.

8. The image forming apparatus according to claim 4,
wherein the one of the developers forming an uppermost one of the layers has a higher viscoelasticity than the other developers forming lower layers.

9. The image forming apparatus according to claim 5,
wherein the one of the developers forming an uppermost one of the layers has a higher viscoelasticity than the other developers forming lower layers.

10. The image forming apparatus according to claim 6,
wherein the one of the developers forming an uppermost one of the layers has a higher viscoelasticity than the other developers forming lower layers.
